(19) United States
(12) Patent Application Publication
(10) Pub. No.: US 2011/0259213 A1
(43) Pub. Date: Oct. 27, 2011

(54) Foot Actuated Trash Door For Trash Compactor

(75) Inventor: SOHIEL AZIZI, IRVINE, CA (US)

(73) Assignee: MAG AEROSPACE INDUSTRIES, INC., CARSON, CA (US)

(21) Appl. No.: 13/094,347

(22) Filed: Apr. 26, 2011

Related U.S. Application Data
(60) Provisional application No. 61/343,256, filed on Apr. 26, 2010.

(51) Int. Cl. B30B 15/30

(52) U.S. Cl. 100/215; 100/35

(57) ABSTRACT

Embodiments of the present invention relate generally to a foot actuated trash door that creates a chute for a trash compactor.

This application claims the benefit of U.S. Provisional Application Ser. No. 61/343,256, filed Apr. 26, 2010 titled “Foot Actuated Trash Door for Trash Compactor,” the entire contents of which are hereby incorporated by reference.

### FIELD OF THE INVENTION

Embodiments of the present invention relate generally to a foot actuated trash door that creates a chute for a trash compactor.

### BACKGROUND

Collecting and disposing of trash in confined conditions, particularly on-board passenger transport vehicles, such as aircraft, trains, ships, buses, RVs, and other water or air travel vessels can be challenging. However, a good deal of rubbish is generated on such vehicles. For example, after in-flight beverage service, unused items are collected, which often includes drink cups, napkins, newspapers, food wrappers, tea bags, beverage cans, other packaging or non-consumable items and the like, food wastes, or any other type of disposable item that a passenger may consume or bring on-board. Typically, waste items are compacted on-board passenger transport vehicles in order to preserve space.

Trash compactors typically have a main door that allows access to an interior of the trash component. The main door further features a trash opening, such as a trash door or trash window, that creates and provides a path or “chute” into the compactor carton or trash collection chamber. Present stationary trash compactors use a hand-operated trash door or window that is operated by gripping a handle or grasping an internal lip and applying pressure (e.g., typically a pulling action) to open the trash door. Un-compacted trash material is loaded sideways into the trash box inside the compactor cabinet. Particularly on busy flights or trips, attendants may find themselves needing to quickly dispose of trash when their hands are full. In this instance, opening the trash door in order to dispose of the items requires the attendant to empty his or her hands, open the door, and then pick the trash back up for disposal. It is thus desirable to provide more convenient and more efficient ways to open the compactor trash door.

### BRIEF SUMMARY

Embodiments of the present invention provide a trash compactor, comprising a main door for accessing an internal portion of the trash compactor, the main door comprising a trash opening; a foot actuated trash door configured to cover the trash opening; and a foot pedal positioned at or near a lower portion of the main door for opening the trash door. The foot actuated trash door may comprise collapsible side portions, which in a specific embodiment, are accordion-like side louvers. The trash door is generally configured to stay open while a user's foot depresses the foot pedal and to close when the foot pedal is released, allowing a user to access the trash compactor with having to use one's hands to open the trash door.

### BRIEF DESCRIPTION OF THE DRAWINGS

FIG. 1 shows a front perspective view of one embodiment of a foot actuated trash door in an open position.

FIG. 2 shows a rear perspective view of one embodiment of a foot actuated trash door in an open position.

FIG. 3 shows a front perspective view of one embodiment of a trash compactor unit having a foot actuated trash door.

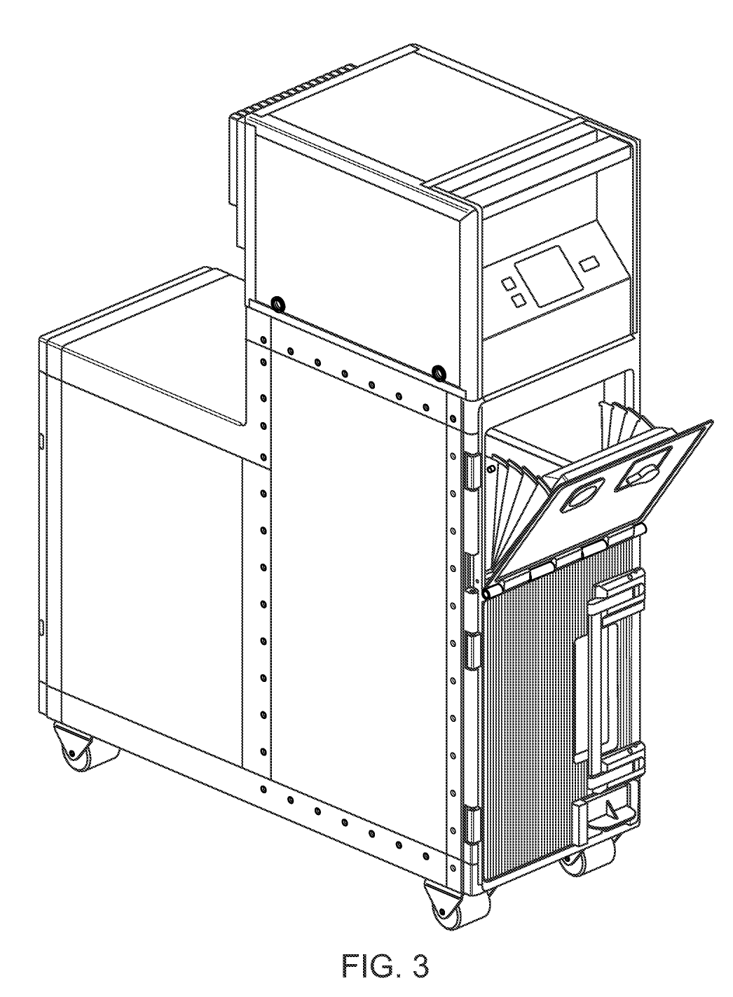

### DETAILED DESCRIPTION

Embodiments of the invention generally relate to a foot actuated trash door that allows hands-free opening of the door for disposal of trash into the compactor. It should be understood that a number of possible door configurations and opening mechanisms are possible. The general concept is that a foot pedal actuates the trash door positioned at an upper portion of the trash compactor main door. This allows hands-free loading of the trash compactor, as opposed to having to open the entire main door or having to open the trash door by hand.

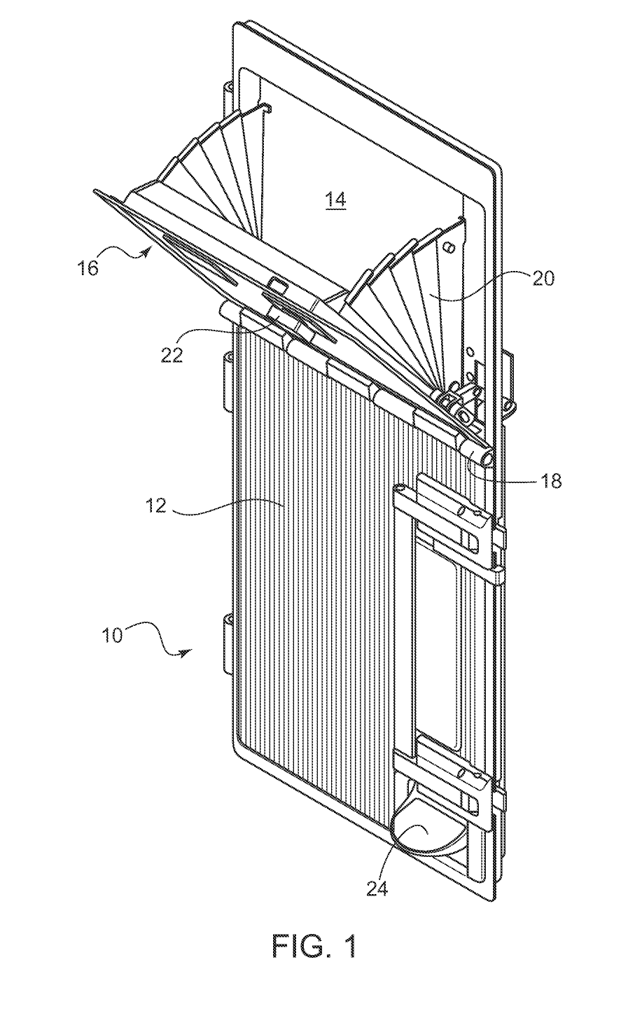

As shown in FIG. 1, the trash compactor has a main door 10, which includes a body panel 12 and an opening 14. Opening 14 provides access to an interior portion of the trash compactor for loading trash to be compressed. Providing opening 14 at an upper portion of main door 10 allows for easy top loading of the compactor. A trash door 16 is secured to main door 10 such that it remains closed when not in use, and can easily be activated when necessary. In the embodiment shown, trash door 16 is secured to main door along a bottom edge of trash door 16 via at least one hinge 18. The hinge 18 may extend the entire distance horizontal distance of trash door 16, it may be a single smaller hinge 18, or it may be a series of hinges that secure door 16 in place. (Although proving hinge 18 along the horizontal lower edge of the trash door 16 is shown and is believed to provide the most ease of use, it should be understood that it is possible to provide a hinge along a vertical edge of the trash door 16 so that door 16 swing open from left to right.)

Along sides of trash door 16 are collapsible side portions 20, which help guide trash in to the unit. In the embodiment shown, the side portions are accordion-like folding louvers 20, and when trash door 16 is released open, the louvers 20 create a chute-like path to the compaction area. This chute-like feature is beneficial to catch stray rubbish that may seek to slide out the sides of open trash door 16 without louvers 20 in place. Louvers may be made of any appropriate material, such as plastic, metal, wood, aluminum or any other appropriate material. Alternatively, instead of louvers, it may be possible to provide a flexible fabric along door sides in order to provide collapsible side portions. Louvers or fabric also help maintain the door 16 at the preferred angle and can help prevent it from flapping open further. They can also help prevent strain on the activation system that operates the door by supporting door when in an open position. Moreover, collapsible side portions 20 do not interfere with the action of the platen during the compression cycle because they cause the side to fold upon itself. By contrast, providing non-collapsible or non-flexible sides, such as solid metal or aluminum sides that would slide into the interior of the unit when the door 16 is closed, could potentially interfere with the platen during the compression cycle or the platen could press against or damage non-collapsible sides. At an upper portion of trash door (or anywhere along its edges), there is typically a quarter turn element 22, which provides a secondary restraint for the door in line with current FAA standards and requirements.

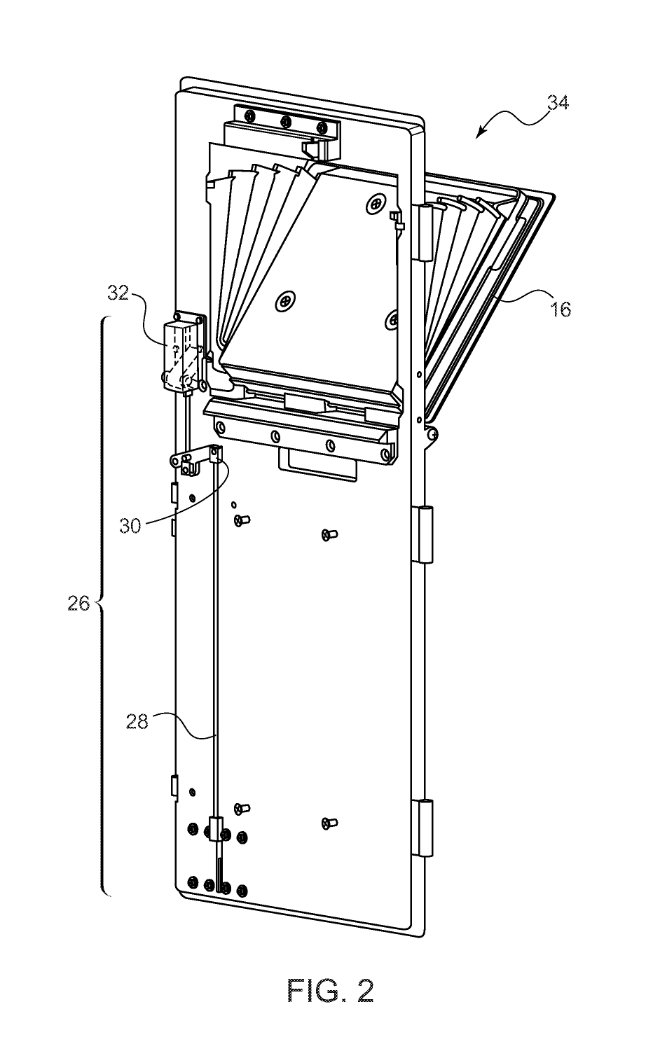

A foot pedal 24 is provided on the lower portion of the main door. Typical action for foot pedal 24 is to be depressed downwardly with the ball of a user's foot, although it is possible for the action to be a lifting up of the pedal with the user's toes. As shown in FIG. 2, an activation system 26 is provided that operably connects the foot pedal 24 with the trash door 16 in order to open and close the trash door 16 when the foot pedal 24 is activated. The foot actuated trash door 16 is generally configured to stay open while a user's foot depresses the foot pedal 24 and to close when the foot pedal 24 is released.

In the embodiment shown, activation system 26 may comprise a vertical rod 28, a pivot lever 30, and a door release mechanism 32. In use, the vertical rod 28 is associated with the foot pedal, the pivot lever 30 is associated with the vertical rod 28, and the door release mechanism 32 is associated with the pivot lever 30. Downward pressure on the foot pedal 24 raises the vertical rod 28, which causes the pivot lever 30 to pivot, which causes the door release mechanism 32 to open the trash door 16. Although one mechanical method of operating the door is shown and described, it should be understood that any number of methods and configurations may be used and are considered within the scope of this disclosure.

The foot actuated trash door activation system 26 is generally designed to open the trash door 16 and maintain the door open at approximately about 30 to about 50 degrees with respect to the main door, and more specifically, at about 40 degrees. The open door creates a chute 34 that allows for loading trash from the top of the compactor. One of the primary benefits of this design is that this frees up both of the operator's hands to better handle the trash. When the foot pedal 24 is released, the trash door may close via a spring-loaded closure mechanism that also allows hands-free closure of the door.

Changes and modifications, additions and deletions may be made to the structures and methods recited above and shown in the drawings without departing from the scope or spirit of the invention and the following claims.

What is claimed is:

1. A trash compactor, comprising:
(a) a main door for accessing an internal portion of the trash compactor, the main door comprising a trash opening;
(b) a foot actuated trash door configured to cover the trash opening; and
(c) a foot pedal positioned at or near a lower portion of the main door for opening the trash door.

2. The trash compactor of claim 1, wherein the foot actuated trash door is hinged along a bottom portion of the door.

3. The trash compactor of claim 1, wherein the foot actuated trash door comprises collapsible side portions.

4. The trash compactor of claim 3, wherein the collapsible side portions comprise louvers.

5. The trash compactor of claim 4, wherein the side louvers are accordion-like and are configured to create a funnel-like chute into the trash compactor.

6. The trash compactor of claim 1, wherein the foot actuated trash door is configured to stay open while a user's foot depresses the foot pedal and to close when the foot pedal is released.

7. The trash compactor of claim 1, wherein an activation system is provided to operably connect the foot pedal and the trash door.

8. The trash compactor of claim 7, wherein the activation system comprises a vertical rod associated with the foot pedal, a pivot lever associated with the vertical rod, and a release mechanism associated with the pivot lever, such that downward pressure on the foot pedal raises the vertical rod, which causes the pivot lever to pivot, which causes the release mechanism to open the trash door.

9. The trash compactor of claim 1, wherein the foot actuated trash door opens at about 30 to about 50 degrees with respect to the main door.

10. The trash compactor of claim 9, wherein the foot actuated trash door opens at about 40 degrees with respect to the main door.

11. The trash compactor of claim 1, wherein when the foot actuated trash door is open, it provides a trash chute.

12. The trash compactor of claim 1, wherein the trash compactor is a top load compactor, such that waste is loaded into the opening while the main door remains closed.

13. The trash compactor of claim 1, wherein the trash compactor is on-board a passenger transport vehicle.

14. A method for activating a trash door of a trash compactor, comprising:
(a) accessing a trash compactor, comprising (i) a main door for accessing an internal portion of the trash compactor, the main door comprising a trash opening; (ii) a foot actuated trash door configured to cover the trash opening; and (iii) a foot pedal positioned at or near a lower portion of the main door for opening the trash door, with an activation system that operably connects the foot pedal and the trash door;
(b) activating the foot pedal and causing the trash door to open while the main door stays closed;
(c) loading trash into the trash compactor.
